(19) United States
(12) Patent Application Publication
(10) Pub. No.: US 2008/0270280 A1
(43) Pub. Date: Oct. 30, 2008

(54) COMPREHENSIVE, INTEGRATED SYSTEM AND METHOD FOR CALCULATING AND DEMONSTRATING COSTS SAVINGS VALUES

(75) Inventors: Clyde Allen Major, Wheaton, IL (US); Kevin Alan Hartler, Naperville, IL (US)

Correspondence Address: GREENBERG TRAURIG, LLP, 77 WEST WACKER DRIVE, SUITE 2500, CHICAGO, IL, 60601-1732, US

(73) Assignee: W.W. GRAINGER, INC., Lake Forest, IL (US)

(21) Appl. No.: 12/164,433

(22) Filed: Jun. 30, 2008

Related U.S. Application Data
(62) Division of application No. 10/839,115, filed on May 5, 2004.

(51) Int. Cl. G06Q 40/00

(52) U.S. Cl. 705/35

(57) ABSTRACT

A cost savings calculator plan is established for a customer by associating calculator instances, selected from an established plurality of calculator types, with a customer profile. The calculator instances associated with the customer profile are utilized to determine specific cost savings amounts for the customer. The specific cost savings amounts may be presented to the customer using different specified levels of granularity.

### RELATED APPLICATION

This application is a divisional of and claims the benefit of U.S. application Ser. No. 10/839,115 filed on May 5, 2004.

### BACKGROUND

The following disclosure relates generally to systems and methods for calculating costs and, more particularly, to a comprehensive, integrated system and method for calculating and demonstrating costs savings value to customers.

Calculators for estimating a cost associated with an aspect of doing business are known in the art. For example, United Parcel Service of America, Inc. (“UPS”) provides a calculator for use in estimating a cost associated with shipping one or more modules. This stand-alone cost calculator, located at the UPS Web site (www.ups.com), allows a user to interact with a Web page form to specify an origin (e.g., by country, city, and/or postal code), a destination (e.g., by country, city, and/or postal code), and the number of modules to be shipped. Once the Web page form is completed and submitted to the UPS Web site, the UPS Web site uses the information provided to return to the user an estimate of applicable shipping rates.

Published US Application No. 2002/0116273 also describes a system for estimating costs associated with the shipment of items. In the described system, user entered shipment specific information is compared to a database containing rules and applicable duties and/or taxes for a specified destination. Based on this comparison, the tax and duty determination system determines an estimate of the applicable duties and/or taxes for each item in the shipment and for the shipment as a whole.

While such cost calculators do work for their intended purpose, what is needed is a more comprehensive, integrated system for calculating costs. Specifically, what is needed is a system and method that can, among other things, be used to communicate cost savings concepts, identify cost savings opportunities, enlist customers in cost savings activities, create cost savings agreements, collect data, and document and report cost saving business results all in a consistent and standardized manner. A cost savings process that is capable of being integrated with the overall sales system and system processes is also desired.

### SUMMARY

In accordance with these needs and desires, described hereinafter is a system and method that allows a seller of goods and/or services (hereinafter referred to as “goods”) to document and communicate cost savings to customers through a standardized process. In this manner, the described system and method will, among other things, have the advantage of allowing the seller of goods to solidify customer relationships and ensure revenue growth.

In an illustrative example, the system and method may consist of a network-based, front end application and one or more data repositories. The front end application provides a means for an end-user, i.e., a seller of goods and/or services, to create a customer profile, populate and pull data from various data repositories, and/or generate cost savings performance informational reports. Generally, the customer profile is supported by one or more end-user-specified cost calculators. End-users may thus interact with the customer profile to (among other things): create calculator instances from lists of previously established calculator types; print data collection forms to collect customer and savings data; populate the system with the data; use captured data to determine specific cost savings amounts; record the data and savings in the data repositories; present the savings to customers for approval; change cost savings calculator plans from proposed to accepted, rejected, or realized; and/or generate graphical or printed reports that, for example, track cost savings performance at various levels.

A better understanding of the objects, advantages, features, properties, principles, and relationships of a comprehensive, integrated system and method for calculating costs will be obtained from the following detailed description and accompanying drawings which set forth an illustrative embodiment which is indicative of the various ways in which the objects, advantages, features, properties, principles, and relationships may be achieved.

### BRIEF DESCRIPTION OF THE DRAWINGS

A system and method for calculating costs is described with reference to the following drawings in which:

FIG. 1 illustrates a block diagram of an exemplary computer system in which the principles of the system and method for calculating costs may be employed;

FIG. 2 illustrates a data flow diagram generally depicting exemplary collaboration within the system and method for calculating costs;

FIG. 3 illustrates an exemplary profile search results page;

FIG. 4 illustrates exemplary pages for creating a customer profile;

FIG. 5 illustrates exemplary pages for viewing a customer profile;

FIG. 6 illustrates an exemplary customer performance matrix;

FIG. 7 illustrates an exemplary graphical depiction of customer performance data;

FIG. 8 illustrates exemplary pages for creating cost calculators;

FIG. 9 illustrates exemplary reports showing various levels of cost savings information; and

FIG. 10 illustrates an exemplary calculator type.

### DETAILED DESCRIPTION

Turning to the drawings, wherein like reference numerals refer to like elements, an exemplary comprehensive, integrated system and method for calculating costs is described. While the comprehensive, integrated system is described in the exemplary context of a network of computing devices, e.g., an Intranet, the Internet, or the like, it is to be appreciated that this context is not intended to be limiting. Rather, it is contemplated that the hereinafter described system and method may be utilized in any type of computing environment.

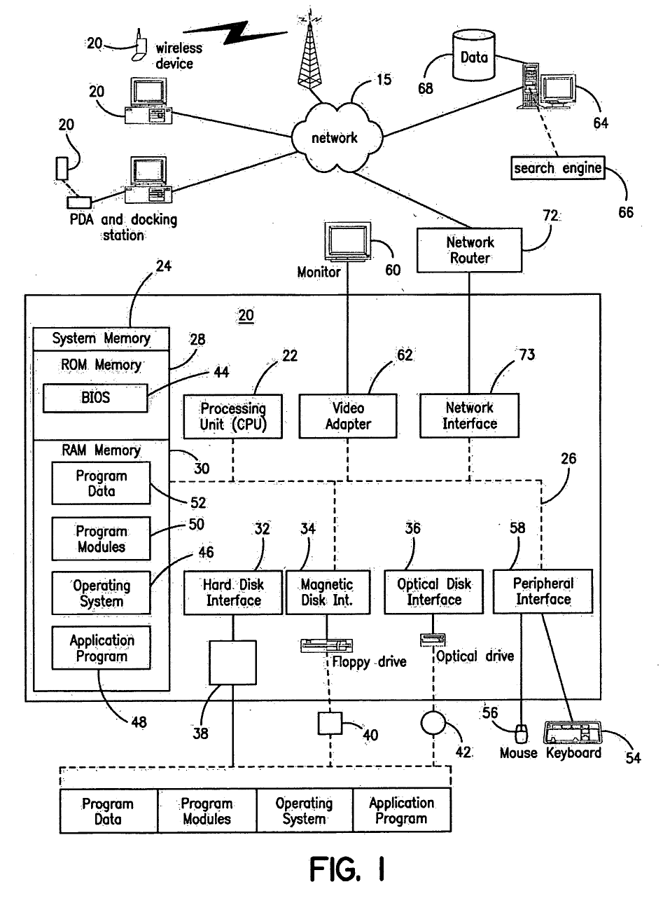

Turning now to FIG. 1, a processing device 20, illustrated in the exemplary form of a computer system, is provided with executable instructions for providing a comprehensive, integrated cost savings calculator system. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a network whereby the executable instructions may be associated with and/or executed by one or more of the multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. By way of further example, the bus 26 may include an architecture having a North Bridge and a South Bridge where the North Bridge acts as the connection point for the processing unit 22, memory 24, and the South Bridge. The North Bridge functions to route traffic from these interfaces, and arbitrates and controls access to the memory subsystem from the processing unit 22 and I/O devices. The South Bridge, in its simplest form, integrates various I/O controllers, provides interfaces to peripheral devices and buses, and transfers data to/from the North bridge through either a PCI bus connection in older designs, or a proprietary interconnect in newer chipsets.

As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 24. Similarly, the RAM 30, hard drive 38, and/or peripheral memory devices may be used to store computer executable instructions comprising an operating system 46, one or more applications programs 48, other program modules 50, and/or program data 52. Still further, computer-executable instructions may be downloaded to one or more of the computing devices as needed, for example, via a network connection.

An end-user may enter commands and information into the processing device 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as a server 64 and associated data repository 68. In this regard, while the remote processing device 64 has been illustrated in the exemplary form of a computer, it will be appreciated that the remote processing device 64 may be any type of device having processing capabilities. Again, it will be appreciated that the remote processing device 64 need not be implemented as a single device but may be implemented in a manner such that the tasks performed by the remote processing device 64 are distributed to a plurality of processing devices linked through a communication network For performing tasks as needed, the remote processing device 64 may include many or all of the elements described above relative to the processing device 20. By way of further example, the remote processing device 64 may include the executable instruction for providing the comprehensive, integrated cost savings calculator system functionality with the processing device 20 being a thin client or a simple input/output device. Communications between the processing device 20 and the remote processing device 64 may be exchanged via a further processing device, such a network router 72, that is responsible for network routing. Communications with the network router 72 may be performed via a network interface component 73. Thus, within such a networked environment, it will be appreciated that program modules depicted relative to the processing device 20, or portions thereof, may be stored in the memory storage device(s) of the remote processing device 64.

To provide the comprehensive, integrated cost savings calculator system functionality, operations will be performed by the processing devices illustrated in FIG. 1. As such, it will be understood that such operations, which are at times referred to as being computer-executed, include the manipulation by the processing devices of electrical signals representing data in a structured form. This manipulation transforms the data or maintains it at locations in the system, which reconfigures or otherwise alters the operation of the processing devices in a manner well understood by those of skill in the art of computer systems. The data structures where data is maintained are physical locations of the memory that have particular properties defined by the format of the data. Nevertheless, while described in the foregoing context, this description is not meant to be limiting as those skilled in the art will further appreciate that various acts and operations described herein may also be implemented, for example, in hardware.

The subject system and method may, for example, be implemented using a tiered architecture where one tier includes a front-end having applications running on, for example, one or more Web server(s) 64 that constitute an interface between users and back-end, client machines 20 of the system. In this manner, authorized users may access the system through, for example, a Web browser having a graphical user interface. Such a user interface may then be implemented using Java applets, HTML pages, etc. To secure the system, the sever application(s) may be surrounded by a firewall.

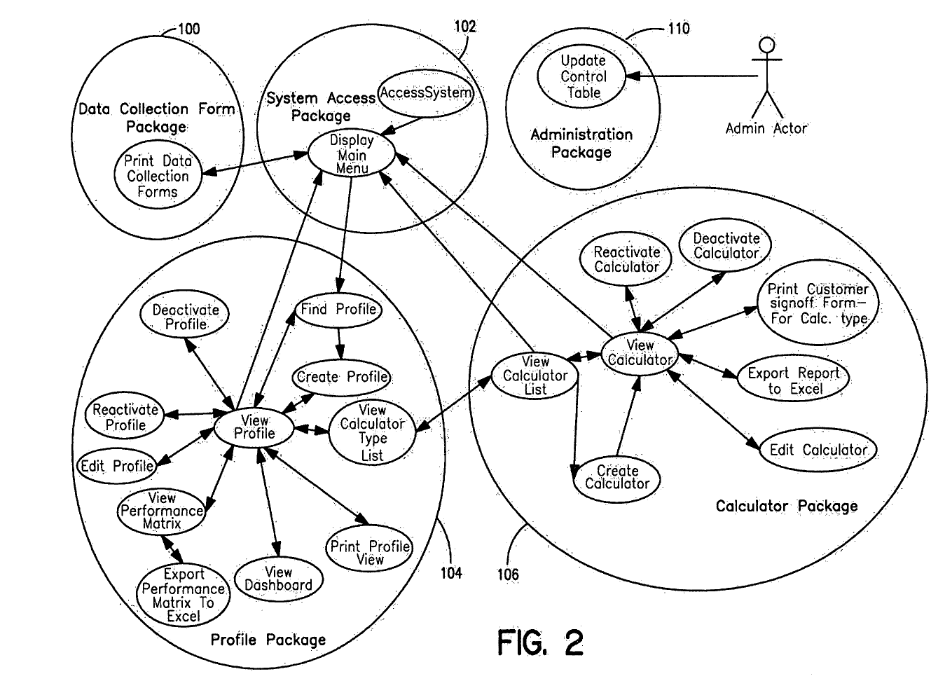

For providing the cost savings system functionality, the system may include one or more program modules that are adapted to collect data 100, control system access 102, create and edit cost savings profiles as well as create and edit cost savings calculators associated with those profiles 104, calculate cost savings 106, create reports, and/or perform system administration 110 as illustrated in FIG. 2. As will be described in greater detail hereinafter, these program modules generally define how sellers will engage with customers to communicate cost savings concepts, identify cost savings opportunities, enlist customers in cost savings activities, create cost savings agreements, collect data, and document and report cost savings business results. More particularly, the program modules allow for the definition and editing of a profile, i.e., an agreement record documenting an overall cost savings agreement with a customer, which profile is supported by one or more cost calculators that apply to the cost savings agreement. Customer data may then be captured and used to determine specific cost savings amounts. Additionally, the program modules may provide for the generation of reports whereby cost saving performances may be tracked at various levels.

For setting up a user to thereby allow the user to access the cost savings calculator system, the system access module 102 generally includes functionality for allowing a system administrator to establish a cost savings calculator system account for a user, such as a customer representative or vendor/sales representative. In connection with the account creation, the system administrator may establish levels of system access for the user, e.g., it may be desirable to limit a customer representative to read-only status. Once an account is created, the user may then be allowed to connect to and access the cost savings calculator system via one or more conventional means. By way of example, connection to the cost calculator system may be performed via a remote company connection, a virtual private network client, a browser loaded on a computing device, etc. Once the cost savings calculator system has been accessed, the user is preferably prompted for their user account identifier as well as a password. It will also be appreciated that a user may register with the cost savings calculator system the first time a user accesses the system. To this end, the system access module 102 may be programmed to elicit information from the user to thereby allow an account to be created for the user. This first time user account may be provided with a default level of system privileges, for example based upon whether the user is a vendor representative having a level of local account manager, district account manager, etc., which authorization level may then be altered by the system administrator as needed.

Once a user has successfully logged into the cost savings calculator system, the system access module 102 may provide the user with a menu of options to allow the user to access various functionalities of the cost savings calculator system, preferably commensurate in scope with system access privileges that have been assigned to that user. By way of example only, the menu may provide for a user to find, create, or edit a customer profile, to access data collection forms, to access reporting capabilities, to access general information, and/or logout.

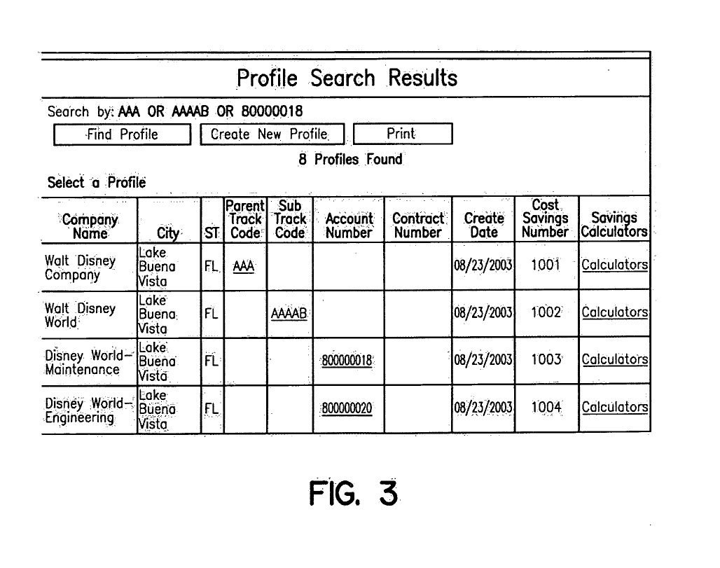

In the event a user selects to find a customer profile, functionality in the profile module 104 may be invoked that requests the user to enter an identifier that is associated with a customer profile of interest. By way of example, the identifier may be in the form of a parent track code, sub-track code, an account number, or the like that has been associated with the customer. Preferably, this function is available to all levels of vendor users but security constraints may be imposed that restrict users from finding customer profiles that are not assigned to that vendor user, e.g., a customer that is not supported by that vendor user. In response to the user entering an identifier, the cost savings calculator system may then search the database and display a list of profiles, if any, that match the search criteria entered as is illustrated by way of example in FIG. 3.

In the example illustrated in FIG. 3, a parent track code, e.g., “AAA” has been assigned to the overall corporate entity of the customer, a sub-track code, e.g., “AAAAB,” which sub-track codes include the parent track code “AAA,” has been assigned to a sub-entity of the overall corporate entity, and account numbers, e.g., “800000018” and “800000020” have been assigned to particular purchasing entities of the sub-entity of the corporate entity. As will be appreciated, these customer profiles have been displayed as they relate to the keys “AAA” or “AAAB” or “800000018” entered as the search criteria. In connection with displaying the customer information (e.g., corporate name, location, contact person, etc.), associated parent code, sub-code, and account number (each as appropriate), the resulting display may also present information concerning the cost savings calculator(s) associated with the customer(s), e.g., creation date and identifier. Preferably, when a parent entity is set up with cost savings calculator(s)—as will be described hereinafter—each purchasing entity, of each sub-entity if further sub-entities have been defined, of that parent entity will have the same cost savings calculator(s) associated therewith when the purchasing entity is entered into the cost savings calculator system (i.e., have a profile created for that purchasing entity). It will be appreciated that a corporate entity and/or a sub-entity may also be purchasing entities in the context of this disclosure and that these labels merely reflect a hierarchical purchasing organization. From the exemplary display illustrated in FIG. 3, a user may, commensurate with their level of authorization, request a customer profile to view or chose an exit option.

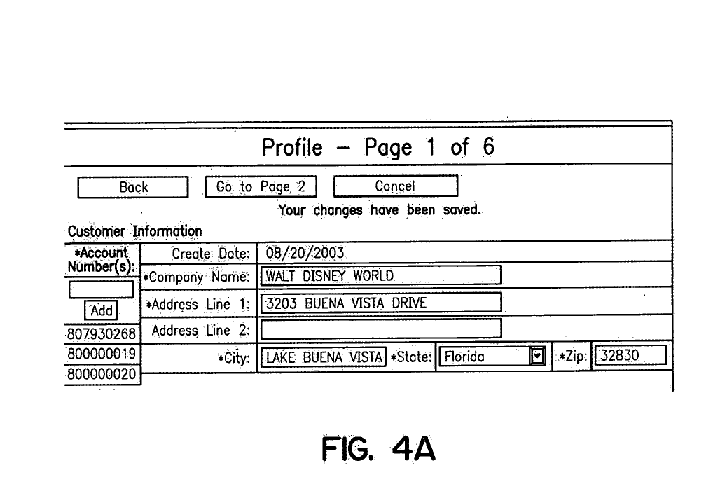

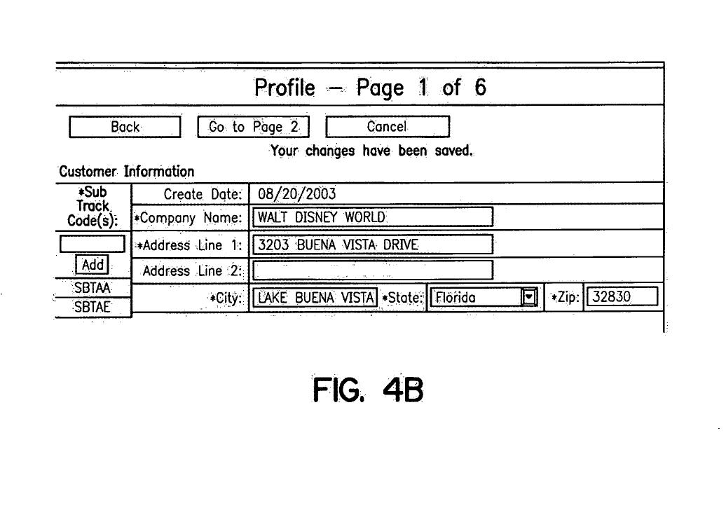

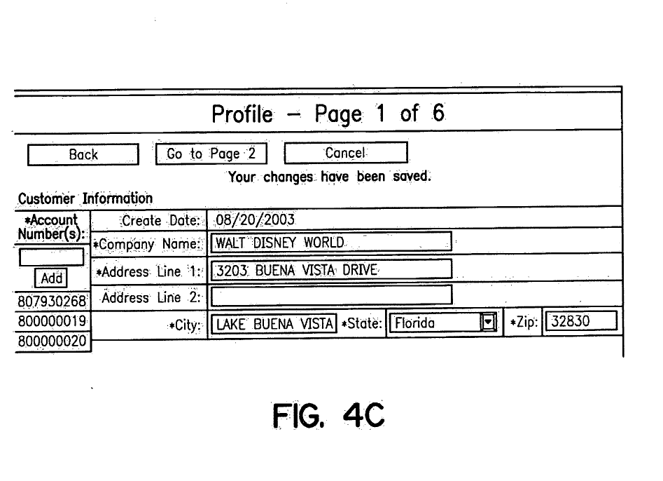

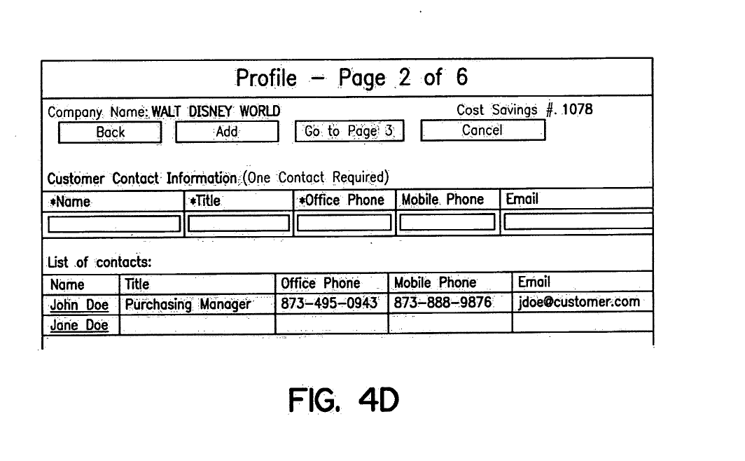

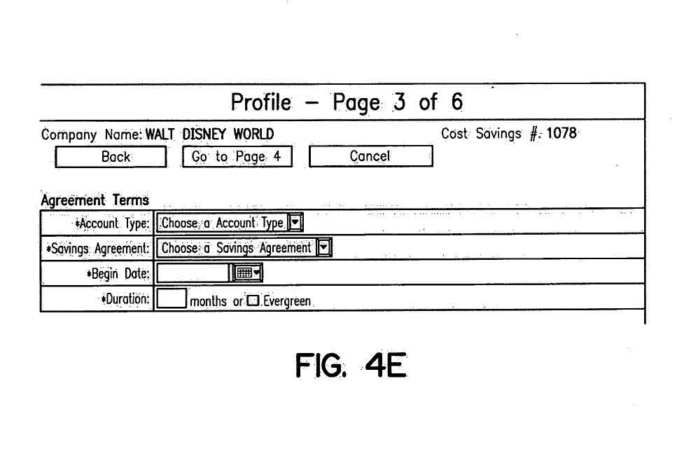

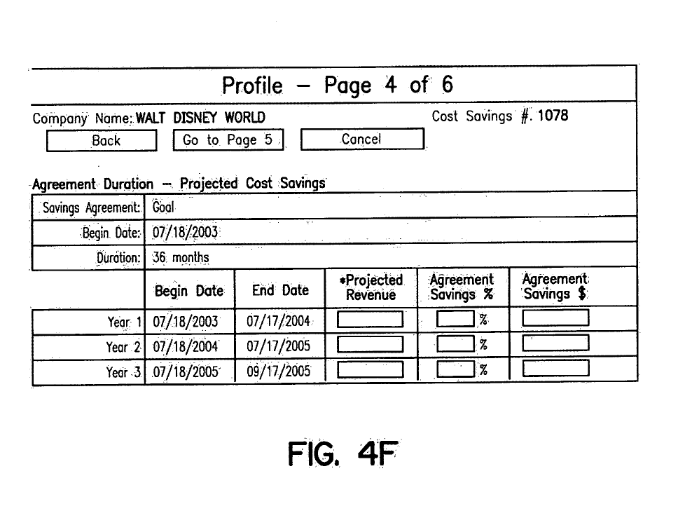

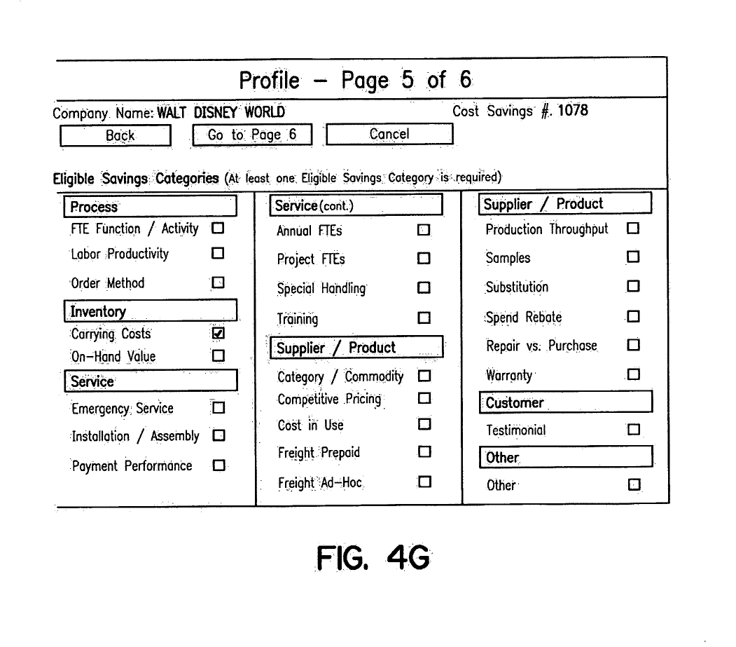

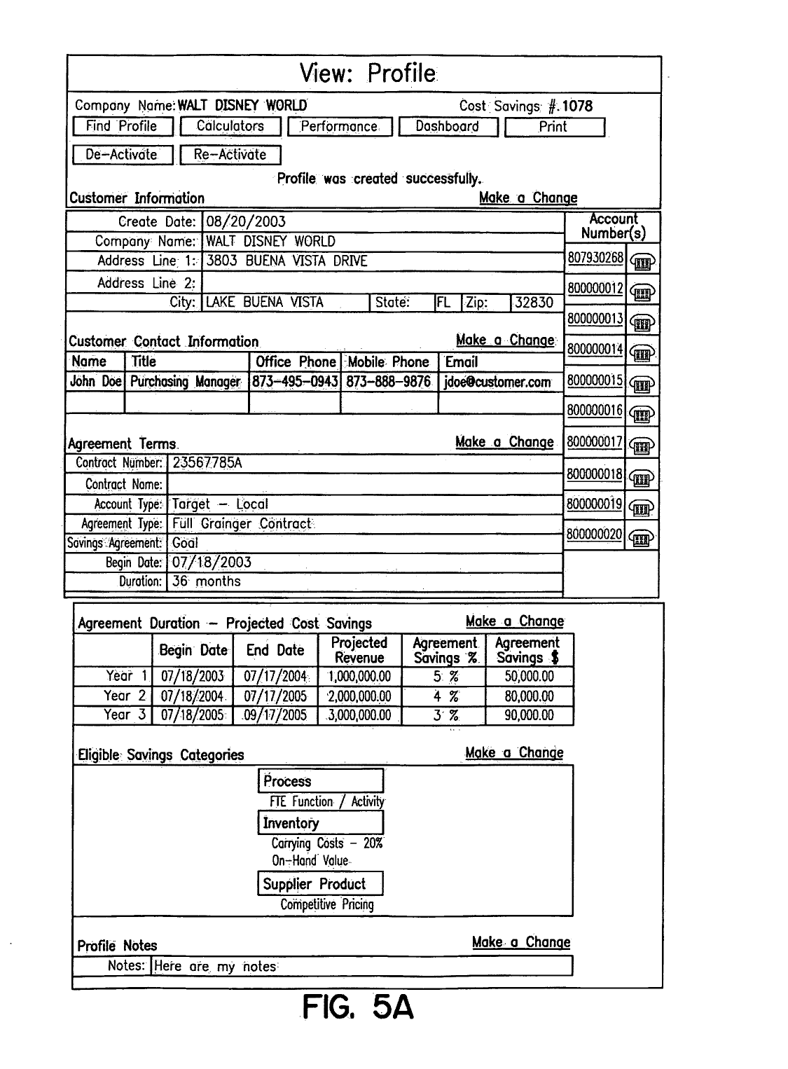

For creating a customer profile, the profile module 104 may include functionality that allows a user to interact with the search results display to access a create a customer profile by parent track code screen, illustrated by way of example in FIG. 4A, a create a customer profile by sub-track code screen, illustrated by way of example in FIG. 4B, or a create a customer profile by account number screen, illustrated by way of example in FIG. 4C. In this example, access to the create a profile by parent track code screen of FIG. 4A may be accomplished by a user activating a link associated with a parent track code, e.g. “AAA,” presented in the profile search results page of FIG. 3. Similarly, access to the create a profile by sub-track code screen of FIG. 4B may be accomplished by a user activating a link associated with a sub-track code, e.g., “AAAAB,” presented in the profile search results page of FIG. 3. Likewise, access to the create a profile by account number screen of FIG. 4C may be accomplished by a user activating a link associated with an account number, e.g., “800000018,” presented in the profile search results page of FIG. 3.

More particularly, in connection with creating a customer profile, the profile module 104 may include functionality for presenting to a user interface page(s) for entering customer data. When data is know to the cost savings calculator system, the costs savings calculator system may pre-populate data entry fields with the known data. The user may then manually enter other data where appropriate. Some data fields may be required to be provided with data while some data fields may be optionally completed. Data to be supplied during the course of creating a customer profile may include customer contact information, additional account numbers, parent track codes, or sub-track codes, etc. as illustrated in FIGS. 4A-4D.

Once the requisite data has been supplied to the cost savings calculator system, verified, and saved to the cost savings calculator database, the user may be presented with an agreement terms user interface an example of which is illustrated in FIGS. 4E and 4F. Using this interface a user may choose an account type, savings agreement, begin date, and duration for the customer profile. In this regard, an account type may include, by way of example only, a “national” account, a “government/federal” account, a “government/state” account, or a “government/local” account. Account types may also include “commercial” accounts, various “government” accounts (as denoted above), or “corporate” accounts. These account type labels, which are not intended to be limiting, are preferably tailored to allow for the collection of meaningful data, such as sales data across a sales force organized by account types. The savings agreement labels may be used to denote a level of intensity for the agreement, i.e., to indicate the degree of commitment the seller organization has to a savings plan. In this context, agreement types may be, for example, “none,” “desirable,” “goal,” “commitment,” or “guaranteed.” The user may also enter data related to projections for the agreement duration, as particularly illustrated in FIG. 4F. Preferably the cost savings calculator system will automatically populate data fields where the values have already been selected and stored. Otherwise the user may manually enter agreement terms information where appropriate. The user may then validate then customer profile agreement data and cause the data to be stored in the cost savings calculator database.

The creation of a customer profile may then continue with the user selecting eligible savings categories from an eligible savings user interface, an example of which is illustrated in FIG. 4G. By way of example only, eligible savings categories, e.g., process, inventory, service, supplier/product, customer, etc., having corresponding cost calculators include, but are not limited to:

I. Process Calculators

(a) FTE Function/Activity—A calculator for deriving annual process cost for staff resources to procure facilities maintenance products and services. Records the number of Full Time Equivalents (FTEs), staff resources that support the procurement process from identification of need to bill payment. Staff resource examples may include, but need not be limited to, professional buyers, accounting clerks, etc. This calculator sums annual labor costs across FTEs to derive cost per purchase order. This calculator utilizes FTE related data gathered by the vendor and/or the customer which is stored within a data repository.
(b) Labor Productivity—This calculator derives cost savings as a result of a reduction in annualized labor. The reduction in annualized labor results from procuring products and services from the vendor. Examples may include, but need not be limited to, products with improved life/usage cycles that require less maintenance time. This calculator utilizes labor productivity related data gathered by the vendor and/or the customer which is stored within a data repository.
(c) Order Method—This calculator derives annual process cost savings related to procurement of facilities maintenance products and services from a vendor. The calculator records customer transaction cost, purchase order cost and potential cost savings depending on an order method selected. This calculator utilizes order method related data gathered by the vendor and/or the customer which is stored within a data repository.

II. Inventory Calculators

(a) Carrying Costs—This calculator derives inventory carrying cost savings as a result of decreasing current on hand inventory levels and values. This calculator utilizes carrying cost related data gathered by the vendor and/or the customer which is stored within a data repository.
(b) On-Hand Value—This calculator derives cost savings as a result of optimizing on-hand inventory levels and associated inventory costs. This calculator utilizes on-hand value related data gathered by the vendor and/or the customer which is stored within a data repository.

III. Service Calculators

(a) Emergency Service—This calculator derives cost savings as a result of providing emergency service in response to customer situations. Cost savings examples may be, but need not be limited to, downtime avoidance. This calculator utilizes emergency service related data gathered by the vendor and/or the customer which is stored within a data repository.
(b) Installation/Assembly—This calculator derives cost savings from installment or assembly of products procured from the vendor. This calculator utilizes installation/assembly related data gathered by the vendor and/or the customer which is stored within a data repository.
(c) Payment Performance—This calculator derives cost savings from extended payments made versus payment terms of the vendor, e.g., 30 days. Applying return on invested capital (ROIC) to outstanding invoice amounts derives the value. This calculator utilizes data reflective of vendor payment terms and customer payment performance stored within a data repository.
(d) Annual Resource—This calculator derives cost savings from the application of a full time resource to a customer at no charge. This calculator utilizes annual resource related data gathered by the vendor and/or the customer which is stored within a data repository.
(e) Project Resource—This calculator derives cost savings from the application of a project, part time resource to a customer at no charge. This calculator utilizes annual resource related data gathered by the vendor and/or the customer which is stored within a data repository.
(f) Special Handling—This calculator derives cost savings from the application of labor/services provided to meet customer requests based on the procurement of products and services. Applying resources derives the cost savings value. This calculator utilizes special handling related data gathered by the vendor and/or the customer which is stored within a data repository.
(g) Training—This calculator derives cost savings as a result of providing resources for product/service training at no charge. Example may include, but need not be limited to, motor application training. This calculator utilizes data provided by the vendor, vendor suppliers and/or the customer which is stored within a data repository.

IV. Supplier/Product Calculators

(a) Category/Commodity—This calculator derives cost savings as a result of executing the category/commodity calculators provided by vendor suppliers/manufacturers. This calculator utilizes category/commodity related data gathered by the vendor, vendor suppliers and the customer which is stored within a data repository.
(b) Competitive Pricing—This calculator derives cost savings as a result of price variance from similar product/service purchased from the vendor as opposed to a competitor of the vendor. This calculator is dependent on competitive pricing related data gathered by the vendor and/or the customer which is stored within a data repository.
(c) Cost In Use—This calculator derives cost savings as a result of switching to products that have longer product life cycles resulting in less frequent replacement. This calculator utilizes cost in use related data gathered by the vendor and/or the customer which is stored within a data repository.
(d) Prepaid Freight (Coded)—This calculator derives cost savings as a result of shipping charges not billed to the customer per negotiated agreements. This calculator utilizes prepaid freight (coded) related data gathered by the vendor and/or the customer which is stored within a data repository.
(e) Prepaid Freight (Policy)—This calculator derives cost savings as a result of shipping charges not billed to the customer per stated sales policy. This calculator utilized prepaid freight (policy) related data gathered by the vendor and/or the customer which is stored within a data repository.
(f) Production Throughput—This calculator derives cost savings as a result of efficiencies in output of a customer's production throughput as a result of products/services purchased from the vendor. Examples may include, but need not be limited to, improved labor efficiency from workplace improvements such as lighting systems. This calculator utilized production throughput related data gathered by the vendor and/or the customer which is stored within a data repository.
(g) Sample—This calculator derives cost savings as a result of product samples given to a customer at no charge. The value of the product sample(s) is based on the customer's current pricing schedule. This calculator utilizes product sample related data gathered by the vendor and/or the customer which is stored within a data repository.
(h) Substitution—This calculator derives cost savings as a result of identification of a functionally equivalent product. This calculator utilizes product substitution related data gathered by the vendor and/or the customer which is stored within a data repository.
(i) Spend Rebate—This calculator derives cost savings from product/service rebate incentives provided by the vendor. This calculator utilizes spend rebate related data gathered by the vendor and/or the customer which is stored within a data repository.
(j) Repair vs. Purchase—This calculator derives cost savings from repairing a product versus purchasing a replacement. This calculator utilizes repair vs. purchase related data gathered by the vendor and/or the customer which is stored within a data repository.
(k) Warranty—This calculator derives cost savings from products/services replaced within a stated warranty policy. Typically, the warranty is determined by a stated sales policy. This calculator utilizes warranty related data gathered by the vendor, vendor suppliers, and/or the customer which is stored within a data repository.

V. Customer Calculators

(a) Testimonial—This calculator records cost savings described/stated by the customer and not captured in other calculator types. This calculator utilizes testimonial related data gathered by the vendor and/or the customer which is stored within a data repository.

VI. Other Calculators

(a) Other—These calculator(s) record any saving(s) not captured in other cost savings types. These calculator utilize other related data gathered by the vendor and/or the customer which is stored within a data repository.
It is to be appreciated that these described calculators are not intended to be limiting and that other calculators, known or developed on the fly, may be integrated into the system. It will also be appreciated that system integration is achieved by allowing data to be exchanged between calculator instances as well as between calculator instances and one or more data repositories.

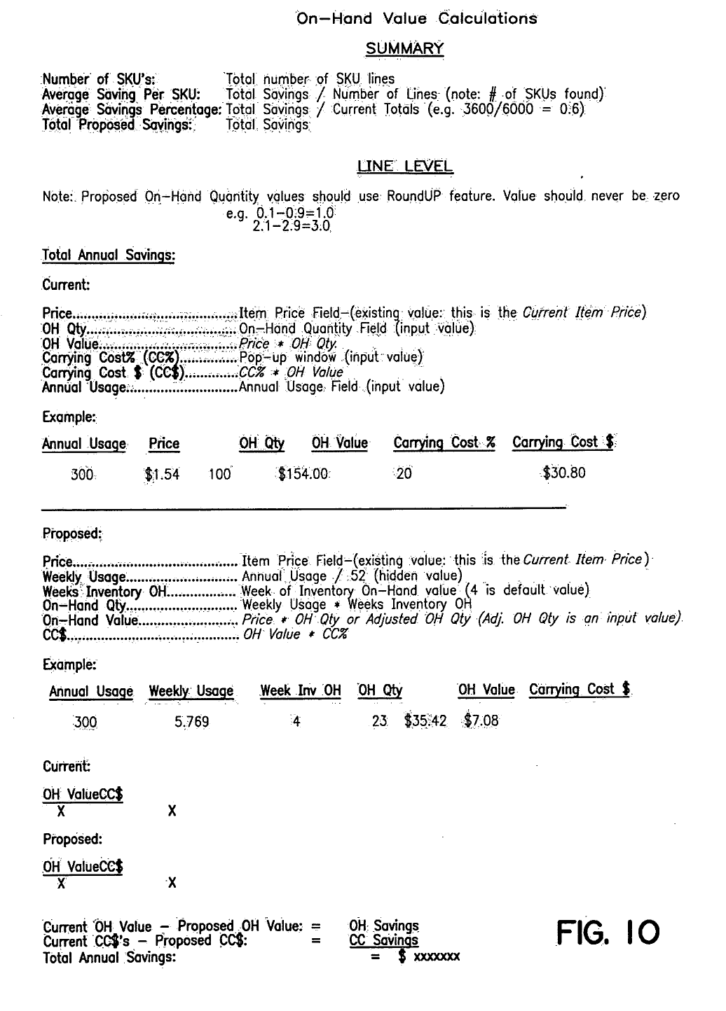

By way of more particular example, FIG. 10 illustrates a calculator for use in calculating savings associated with on-hand inventory.

During the creation of a customer profile, the cost savings calculator system may automatically populate data fields where the values are known. For example, if a parent entity customer profile has already been created then sub-entities for that parent entity will have the same eligible savings categories. Once the fields have been verified by the user, the eligible savings categories for the customer profile may be saved to the cost savings calculator database thus completing the customer profile creation process. Preferably, data to be supplied by the customer is elicited through the use of pre-configured forms generated using the data collection forms module 100. It will also be appreciated that one or more of these steps may be performed to edit an already existing customer profile.

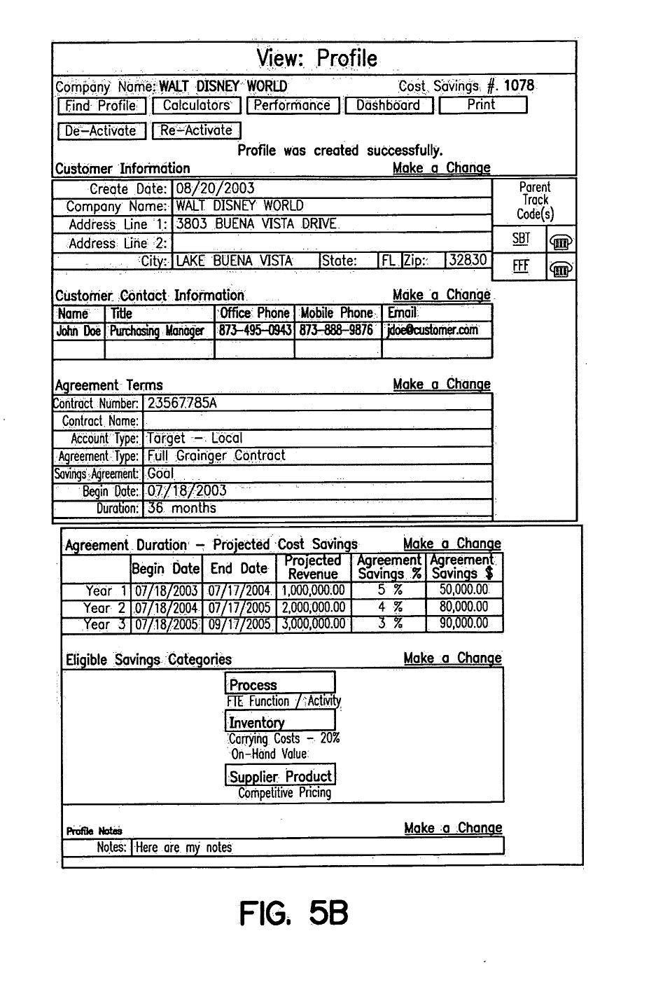

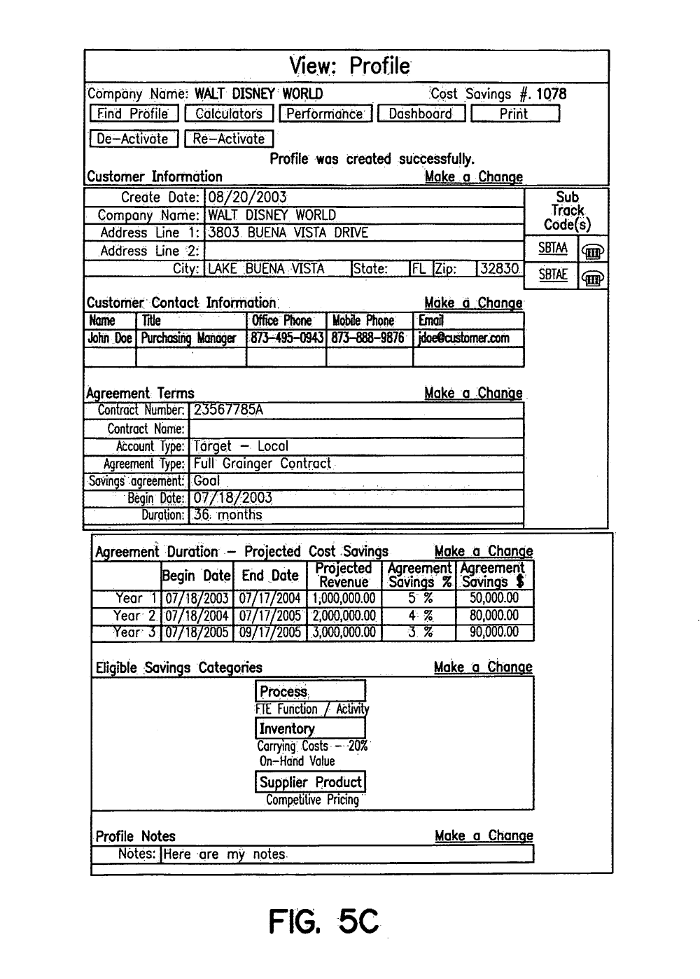

Viewing of a created customer may be accomplished by accessing further functionality provided within the profile module 104. In a customer profile view, examples of which are illustrated in FIGS. 5A-5C, wherein FIG. 5A illustrates an exemplary customer profile view by account number, FIG. 5B illustrates an exemplary customer profile view by parent track code, and FIG. 5C illustrates an exemplary customer profile by sub-track code, information relevant to the customer profile is displayed to the user. This information is reflective of the information entered to create the profile for the customer and may include the customer information generally, e.g., company name, address, etc., customer contact information, agreement terms, agreement duration and projected cost savings determined using the calculators for the eligible savings categories for that customer. From the customer profile view, authorized users may access user interface screens for the purpose of editing the customer profile, in a manner similar to which a customer profile is created, for example by selecting one of the illustrated “make a change” links. Furthermore, the customer profile view may provide links, depicted in the example as telephone icons, by which a user may gain access to contact information for the one or more personnel (within the vendor organization) responsible for the account corresponding to a selected link.

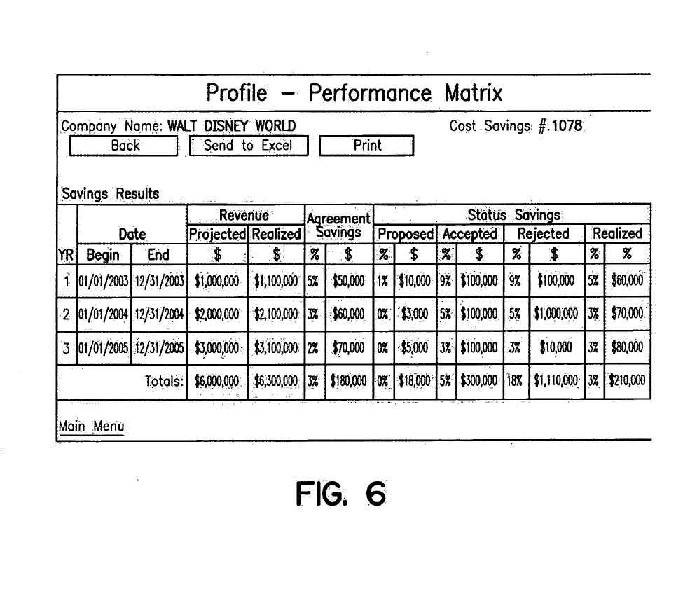

From the display profile views, a menu may also be provided whereby a user may elect to find a profile, view calculators, view performance, view a dashboard, print the profile being viewed, de-activate the profile, activate the profile, etc. At least the functions associated with activation and de-activation of profile may be limited to user having administrative privileges. In particular, selecting view performance may cause the profile module to display a performance matrix an example of which is illustrated in FIG. 6. Generally, the performance matrix allows a user to view the savings and revenue figures from a profile and its associated calculators. As illustrated in the example of FIG. 6, the data may be displayed over various periods of time, such as by year from date of the beginning of the cost savings agreement through the end date of the agreement. Furthermore, the displayed data may include revenue projected savings and realized savings, agreement savings, status savings proposed, accepted, rejected, and realized, etc. each over one or more various periods of time. From the performance view, a user may elect to download the data into a spreadsheet, return to the profile view, print the data being displayed, etc.

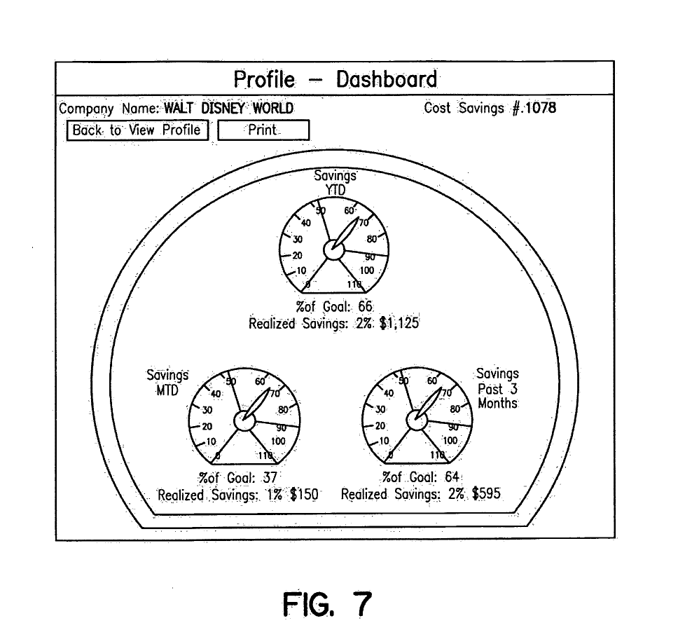

In the case where a user selects to view a dashboard, the profile module 104 may cause the display of a graphical representation of the summary information from a profile and its associated calculators, an example of which is illustrated in FIG. 7. As illustrated, the dashboard advantageous presents summary information to a user in a manner that is quickly understandable by the user. More particularly, the dashboard may present summary information concerning percentages of goals using the metaphor of gauges on an automobile dashboard wherein the gauges may represent a range from 0 percent to, for example, 110 percent of a goal and the needle indicator within the gauge represents the current percentage achieved. Furthermore, colors, such as red, yellow, and green may be used to represent areas within the displayed gauge, for example, under-performing, performing, and over-performing percentages respectively, such that the appearance of the needle indicator within a colored region may also be quickly discerned by a user. While the illustrated example depicts gauges showing percentage goals of cost savings year to date, month to date, and over the past three months, it is to be understood that the gauges need not be limited to these particular goals or the particularly illustrated dashboard dials but may be customized as needed to show any type of cost savings information that is desired to be displayed in a quickly understandable graphical way.

In the event a user selects to deactivate a customer profile record and its associated calculators, the system may first require the user to have a user level of a system administrator. In such a case, a request to deactivate a customer profile causes the profile module 104 to mark a customer profile and its associated calculators so that they become read only for all users. Deactivating a customer profile should not be used to remove data relating to that customer profile from the cost savings calculator system database. Similarly, a request to reactivate a customer profile record and its associated calculators, preferably only capable of being acted upon by a user having the level of a system administrator, causes the profile module 104 to mark a customer profile and its associated calculators so that they become modifiable by users of all or some sub-set of user levels. The cost savings calculator system may also allow a user, preferably only a user having a systems administrator level, to delete a customer profile whereupon the customer profile and associated calculators will be removed from the system database.

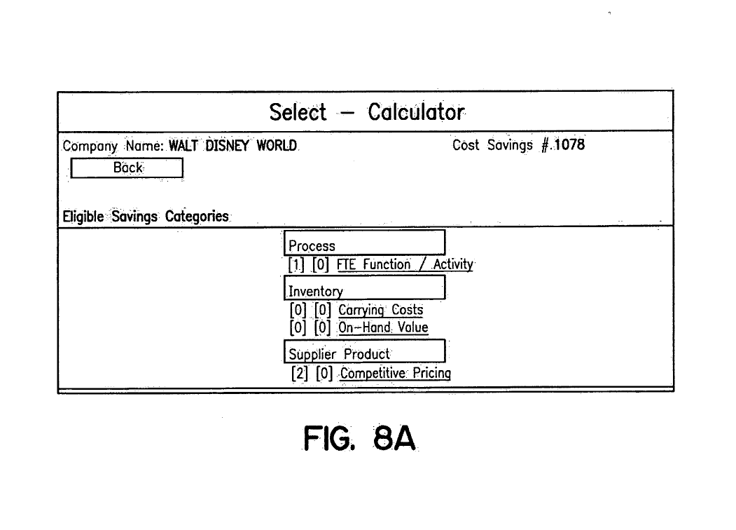

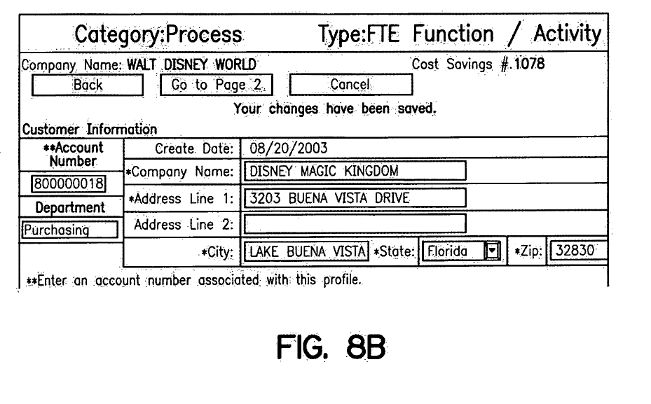

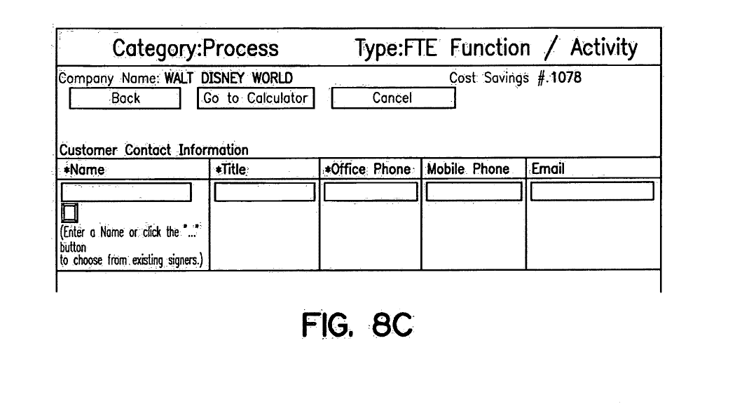

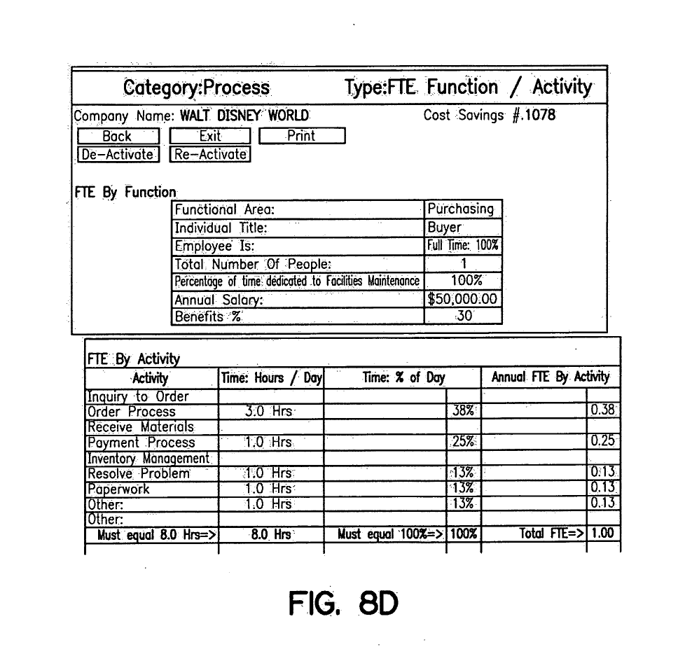

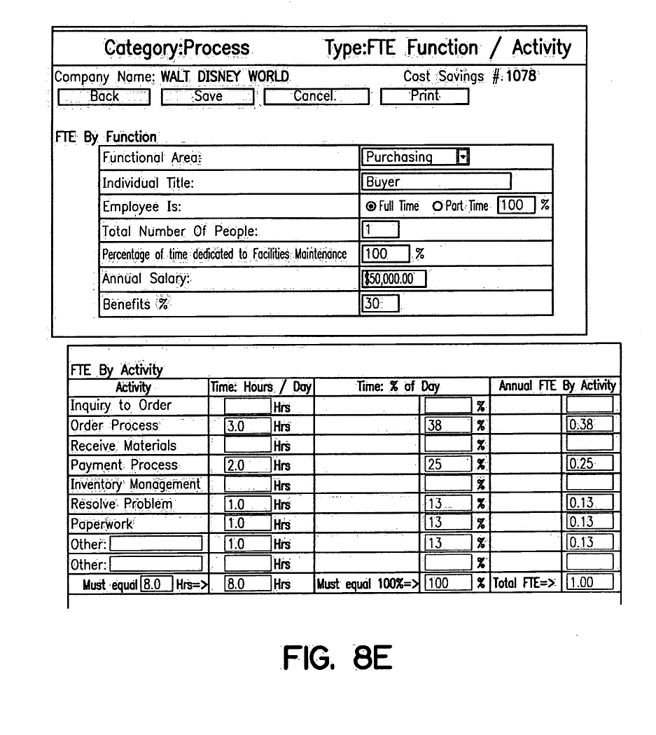

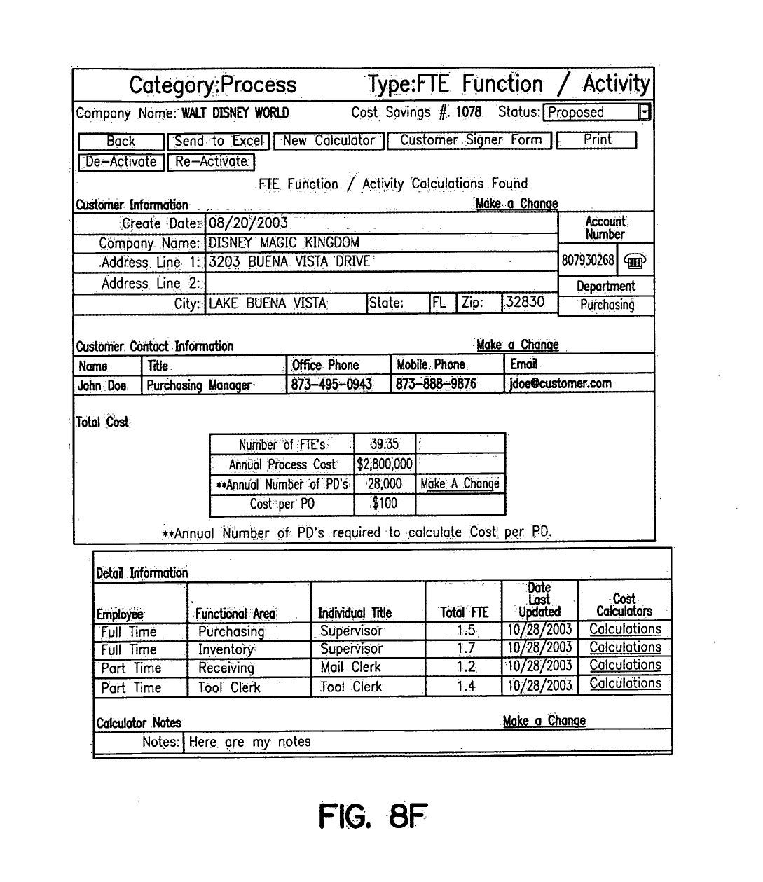

For use in creating calculator instances which are used to calculate and record, i.e., store, cost savings data that apply to a customer profile, the calculator module 106 includes functionality for presenting to a user one or more graphical user interfaces with which the user may interact to establish new calculator instances for a customer profile. Preferably, to associate a calculator with a customer profile the customer profile should be associated with one or more valid account numbers or one or more valid track codes. As illustrated in FIG. 8A, creation of a calculator instance may begin with a user selecting a cost savings calculator from a list of available cost savings calculators that are maintained by the cost savings calculator system. In the example illustrated in FIG. 8A, the user may select from process related saving calculators, e.g., full-time-equivalent (“FTE”) function, inventory related cost savings calculators, e.g., carrying costs or on-hand value, or supplier/product related savings calculators, e.g., competitive pricing. The selectable savings calculators may be limited to only the eligible savings categories established within the customer profile.

Once an eligible cost savings calculator has been selected, it being assumed in this example that the user has selected the FTE calculator, the calculator module 106 may then proceed to present the user with a customer information screen, an example of which is illustrated in FIG. 8B. As illustrated, a customer information screen may present information pertaining to the customer profile of current interest in response to the user entering an account number that is associated with that customer profile. Alternatively, a user may enter information pertaining to a customer profile, e.g., company name, and the system may then prompt the user to enter an account number that has been associated with that customer profile. In either case, the user may enter or update data in the data fields where appropriate and then proceed to the next display screen where the user may enter data relevant to the contact individual(s) associated with the customer, as illustrated in FIG. 8C.

Having entered and/or verified the customer profile information, the user may then proceed to a create calculator instance(s) page for that customer profile where the user supplies information necessary for cost calculations to be performed and tracked/reported. In the case of an FTE calculator, presented by way of example only, the calculator module 106 may cause a list of functional areas for an FTE calculator (e.g., accounts payable, trades, engineering, inventory, maintenance, purchasing, receiving, tool crib, etc.) to be displayed from which a user may select a functional area of interest. The user may then provide information with respect to the employees for which FTE cost calculations are to be performed such as job title, whether the employee is full time or part time (if part time a percentage of time may also be supplied), total number of employees, percentage of time dedicated to facilities maintenance in the selected FTE functional area, annual salary, and benefits percentage, as illustrated in FIG. 8D. The user may be additionally presented with a list of activities (and possibly input fields) for the relevant FTE, such as inquiry to order, order process, receive materials, payment process, inventory management, resolve problem, paperwork, and other (with input field to specify), corresponding time (hours per day and/or percentage of day) spent on the activity (the value for hours per day or percentage of day can be automatically calculated when the other value is provided), annual FTE by activity (the value can be automatically calculated when the time data—hours per day or percentage of day—has been entered). An example of a completed FTE view is illustrated by way of example in FIG. 8E. An example of a summary view of the completed FTE function is illustrated by way of example in FIG. 8F and an example of a download of FTE cost calculations data used in an Excel brand spreadsheet is illustrated in FIG. 8G. While described and illustrated in the context of FTE cost calculations, it will be understood that similar user interfaces and views may be provided for any type of cost calculation.

For creating reports for display, printing, or downloading by a user, the cost savings calculator system may also include a module for generating reports of varying types. In this regard, reports may be generated to aggregate data by seller(s), account types, customers, etc. on various levels of granularity to provide market intelligence as well as customer intelligence. As will be appreciated, data utilized in connection with report generation may be extracted from the data repository and generated data may also be returned to the data repository.

By way of further example, reports that may be generated using the report generating module include, but are not limited to:

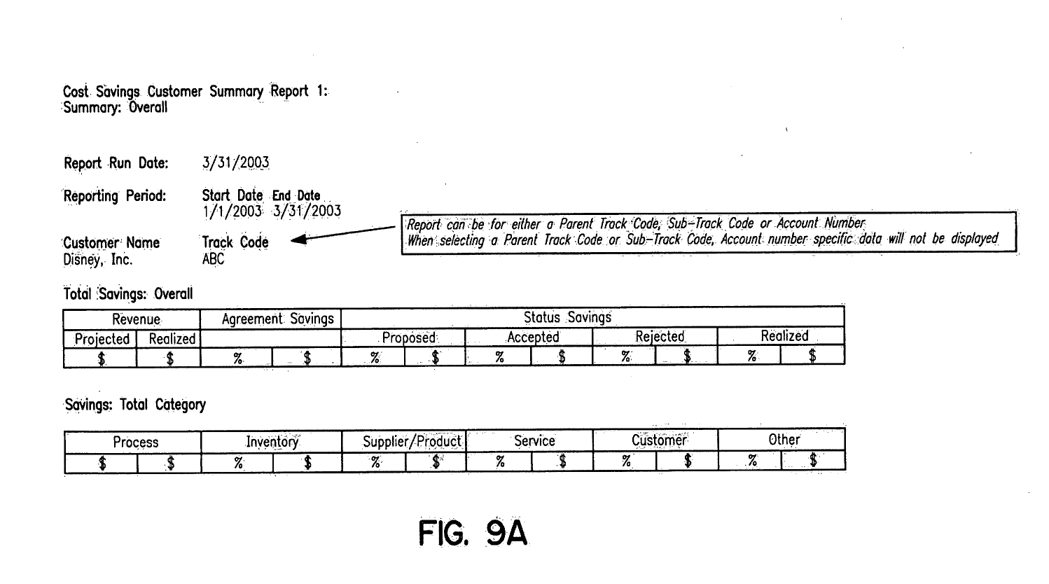

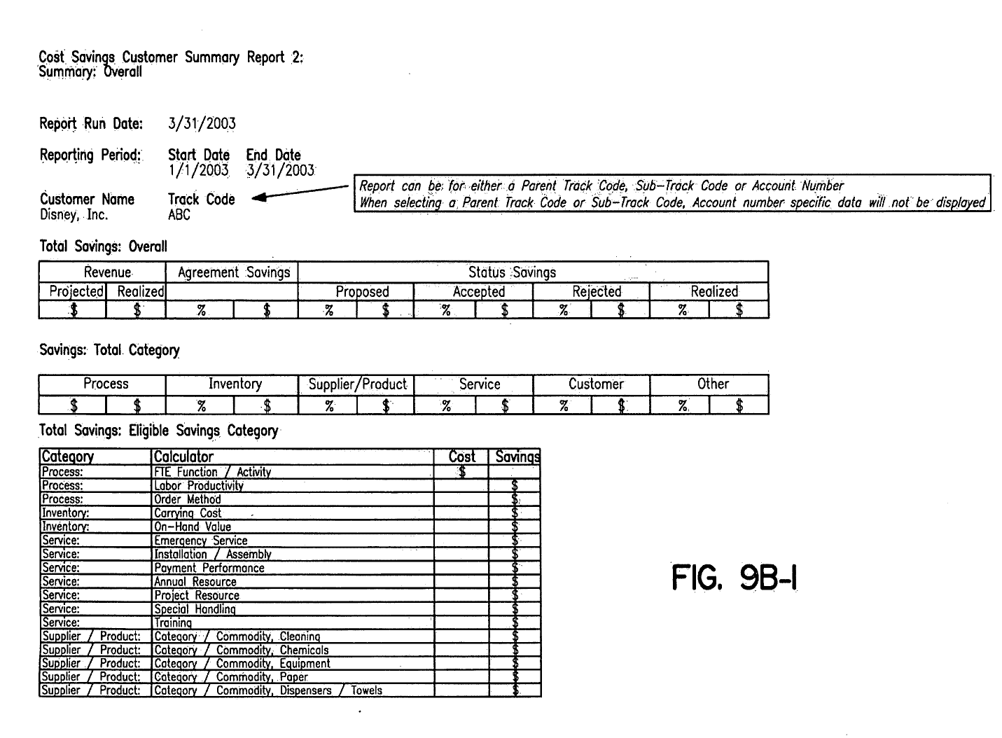

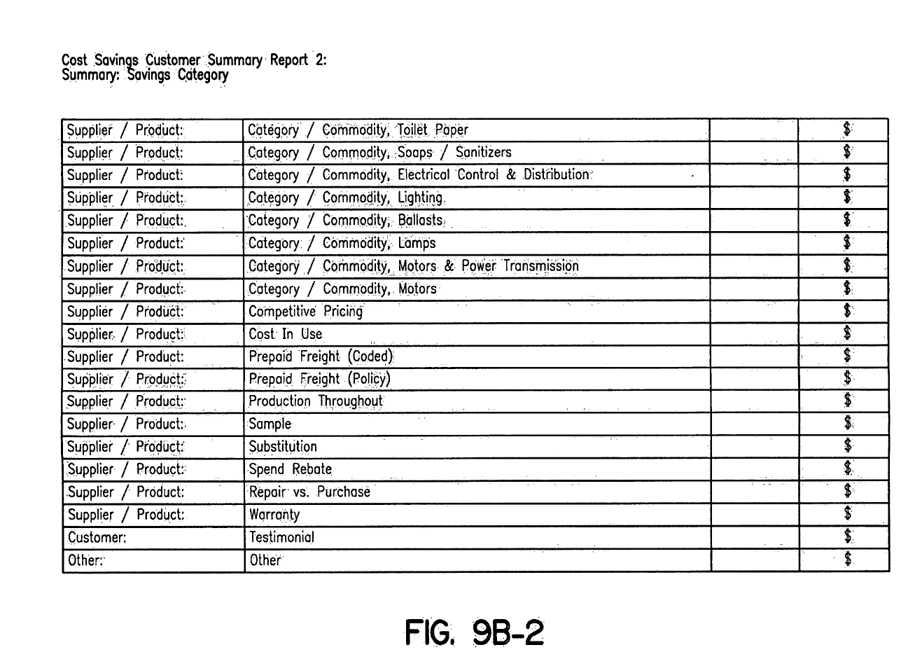

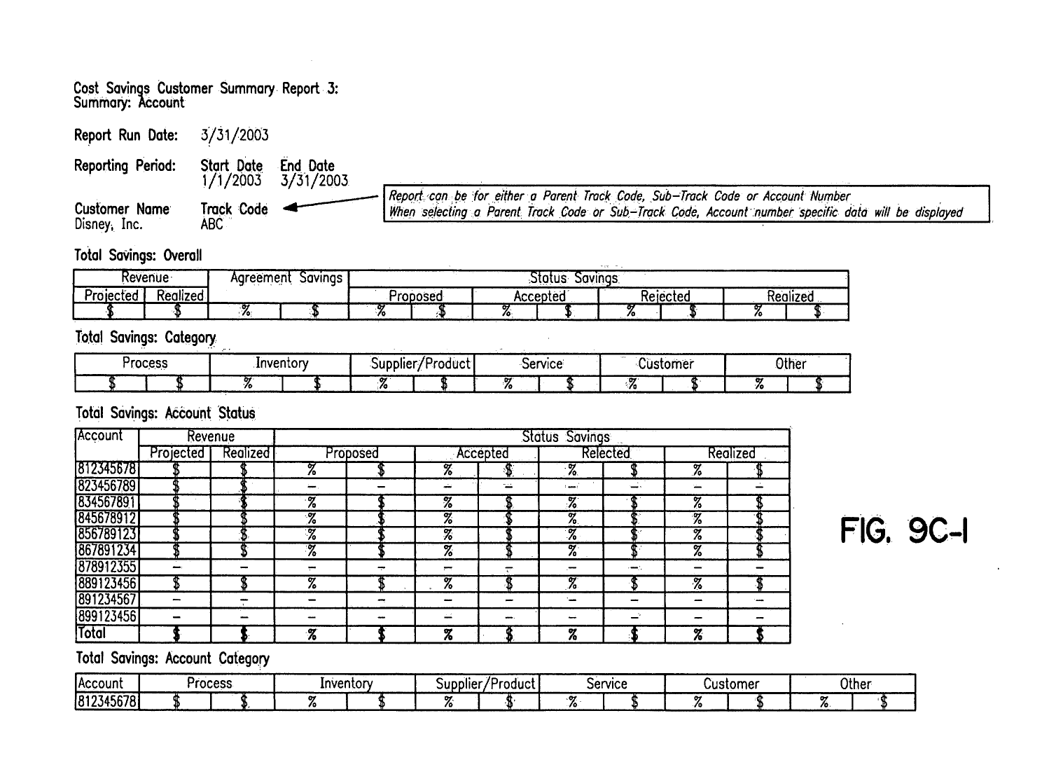

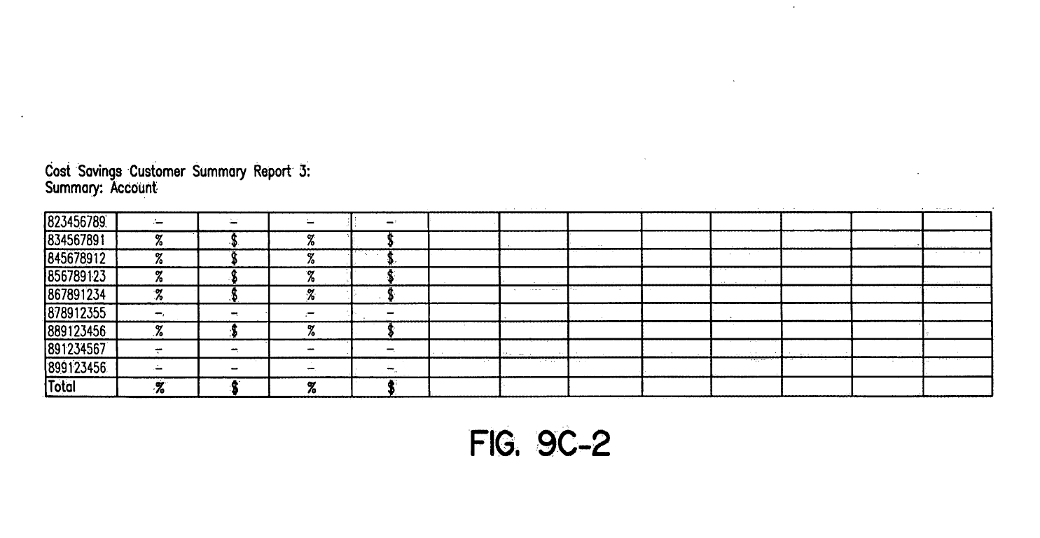

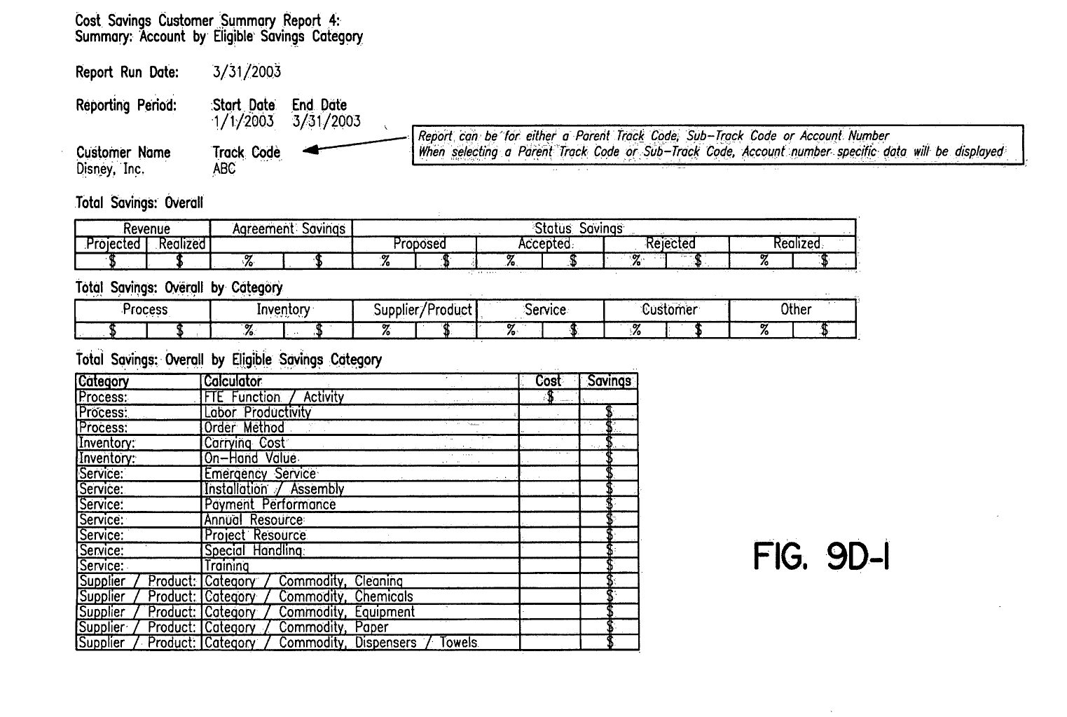

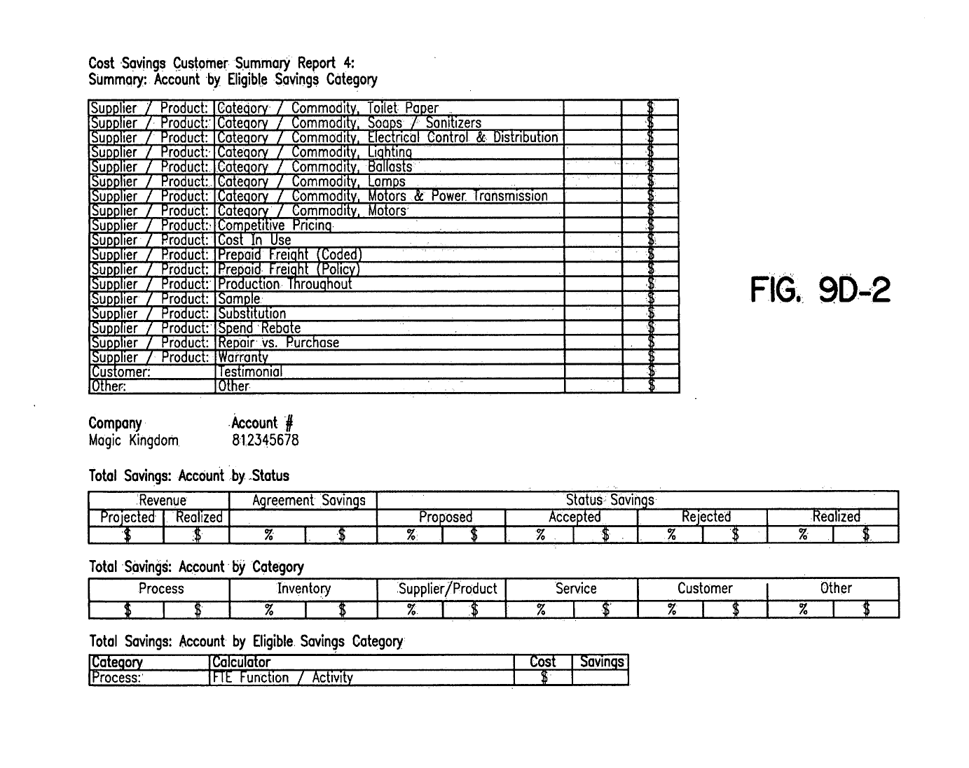

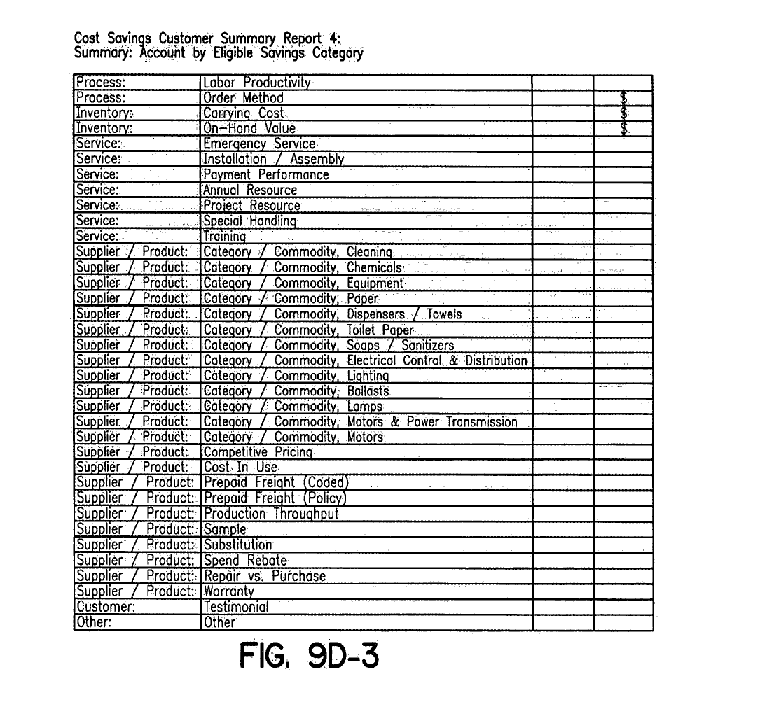

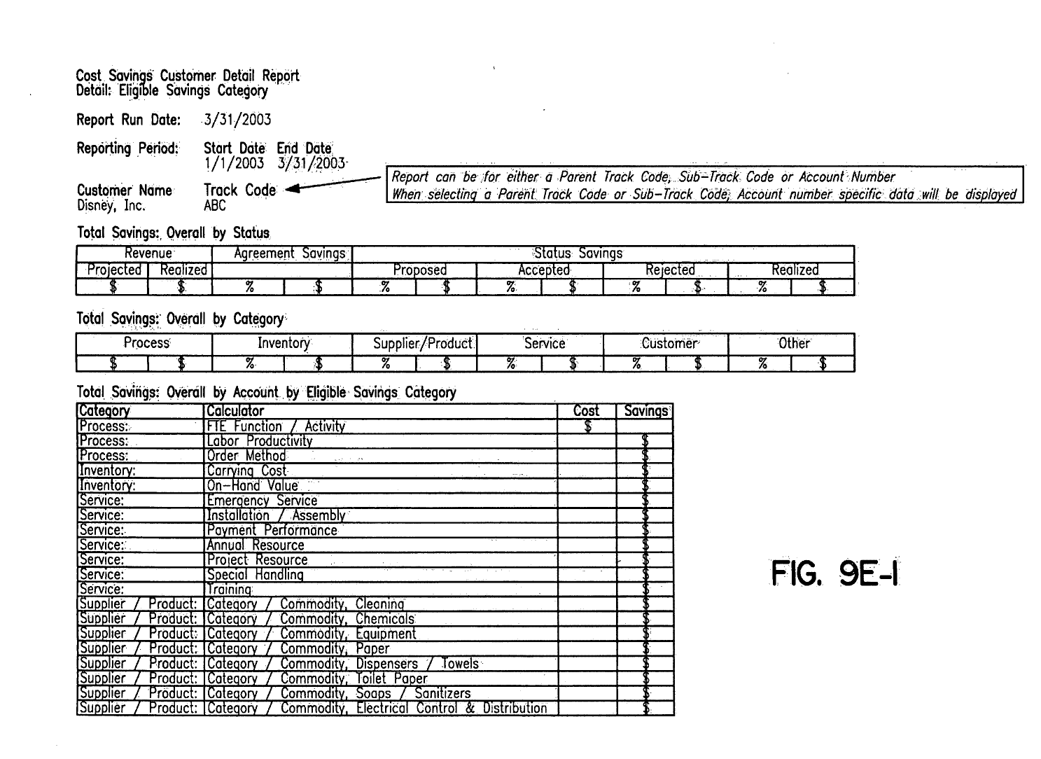

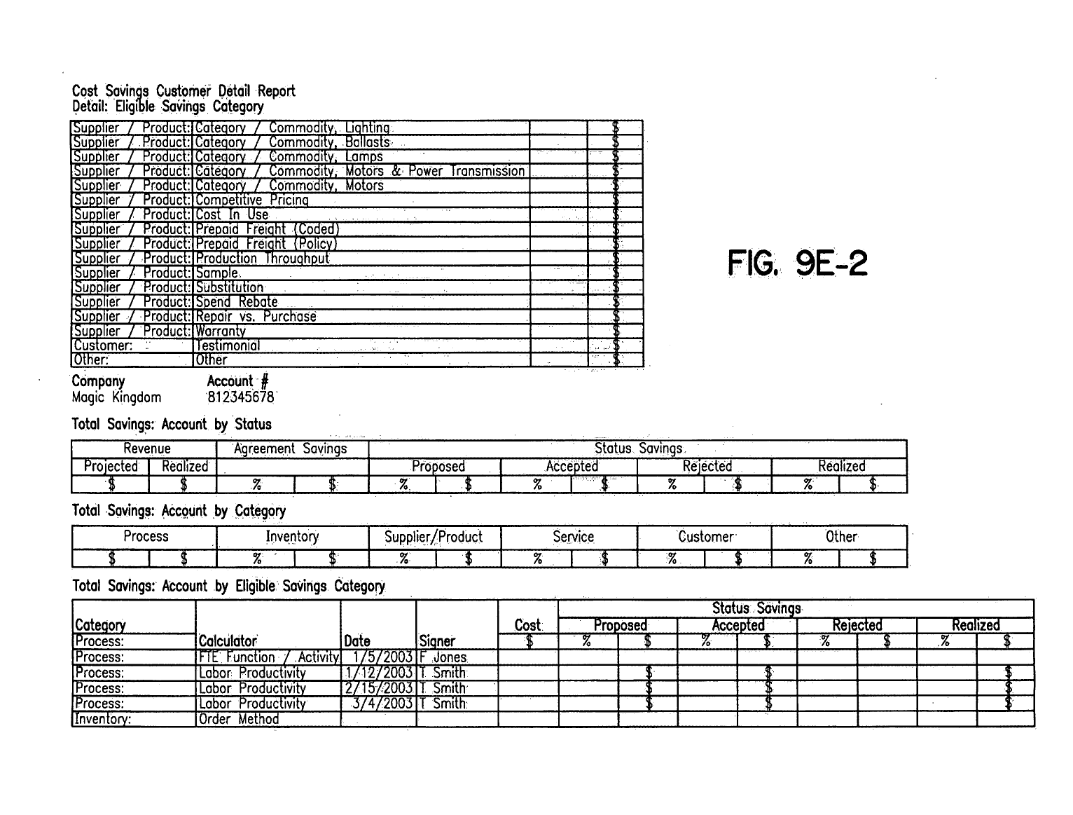

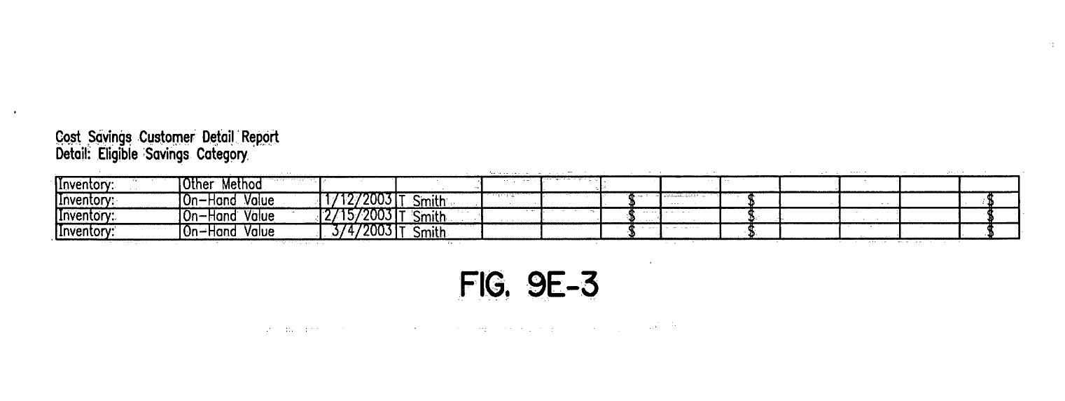

1) A high level customer summary report which generally provides a rollup of all costs savings for a given customer (e.g., all sub-entities of a parent entity would be included) at the highest agreement level (e.g., parent track code) for a specified period. By way of further example, such a report may include data such as a customer number (e.g., track code or account #), customer name, run date of report, report period (e.g., start and end data for data included within the report), projected and realized revenue (e.g., by dollar sales), agreement savings (e.g., by dollar and/or percentage of sales), cost savings proposed, accepted, rejected, and realized (e.g., by dollars and/or percentage of sales), cost savings by high level savings categories, such as process, inventory, supplier/product, service, customer, other (e.g., by dollars and/or percentage of sales). An exemplary high level report is illustrated in FIG. 9A.

2) A customer summary by eligible savings category which generally provides a rollup of all costs savings for a given customer at the highest agreement level (e.g., parent track code) by detailed savings category for a specified period. By way of further example, such a report may include the data in the high level customer summary report with the addition of cost savings by detailed savings category (e.g., by dollars and/or percentage of sales). An exemplary customer summary by eligible savings category report is illustrated in FIG. 9B.

3) A customer summary by account number report which generally provides a rollup of all cost savings for a given customer by account number, by detailed savings category, for a specified period. By way of further example, such a report may include the data in the high level customer summary report with the addition of displaying totals for all accounts included under the cost savings agreement. An exemplary customer summary by eligible savings category report is illustrated in FIG. 9C.

4) A customer summary by account number and by eligible savings category which generally provides a rollup of all costs savings for a given customer by account number, by detailed savings category, for a specified period. By way of further example, such a report may include the data in the customer summary by eligible savings category but run at the account level for all accounts included under the cost savings agreement. An exemplary customer summary by account number and by eligible savings category report is illustrated in FIG. 9D.

5) A customer detail report by eligible savings category which generally provides a rollup of all cost savings for a given customer by account number, by detailed savings category, for a specified period, followed by data from each calculator instance for that customer. An exemplary customer detail report is illustrated in FIG. 9E.

Thus, from the foregoing it will be appreciated that a comprehensive, integrated system and method for calculating and demonstrating costs savings values to customers has been described having, among others, the advantage of unifying costs savings calculations across a network of vendor personnel and customer entities as well as the advantage of providing various levels of detailed reporting of costs savings. Furthermore, while various concepts have been described in detail, it will be appreciated by those skilled in the art that various modifications and alternatives to those concepts could be developed in light of the overall teachings of the disclosure. As such, the particular concepts disclosed are meant to be illustrative only and not limiting as to the scope of the invention which is to be given the full breadth of the appended claims and any equivalents thereof.

What is claimed is:

1. A comprehensive, integrated system for calculating and demonstrating cost savings values, comprising:
a data repository;
a plurality of calculator types which calculate cost savings values utilizing data stored within the data repository;
a graphical user interface for establishing a cost savings calculator plan for a customer by associating calculator instances selected from the established plurality of calculator types with a customer profile; and
a cost calculating system that uses data in the data repository and the calculator instances associated with the customer profile to determine specific cost savings amounts for the customer.

2. The system as recited in claim 1, comprising a system for printing data collection forms for use in capturing customer data to populate the data repository.

3. The system as recited in claim 1, wherein the specific cost savings amounts for the customer profile are recorded within the data repository.

4. The system as recited in claim 3, wherein the graphical user interface provides for displaying the specific cost savings amounts using a dashboard gauge metaphor.

5. The system as recited in claim 4, wherein the dashboard gauge metaphor utilizes color to depict levels of performance.

6. The system as recited in claim 3, wherein the customer has a hierarchical purchasing organization comprised of a parent and at least one sub-entity and a report generator in communication with the data repository allows for the presentation of the specific cost savings amounts for the customer profile at selectable levels of detail across the hierarchal purchasing organization.

7. The system as recited in claim 6, wherein the specific cost savings amounts are presented at the parent level which includes specific cost savings amounts for each sub-entity.

8. The system as recited in claim 7, wherein the specific cost savings amounts are further presented for each savings category within the customer profile for the parent.

9. The system as recited in claim 6, wherein the specific cost savings amounts are presented at the sub-entity level.

10. The system as recited in claim 9, wherein the specific cost savings amounts are further presented for each savings category within the customer profile for the parent of the sub-entities.

11. The system as recited in claim 6, wherein the cost savings calculator plan is established for the parent and the cost savings calculator plan is automatically associated with each sub-entity of the parent.

12. The system as recited in claim 1, wherein access to the graphical user interface is by means of a virtual private network.

13. The system as recited in claim 1, wherein access to the graphical user interface is by means of a remote company connection.

14. The system as recited in claim 1, wherein access to the graphical user interface is by means of an Internet browser.

15. The system as recited in claim 1, wherein access to the graphical user interface is limited to authorized users.

16. The system as recited in claim 2, wherein access to the specific cost savings amounts for the customer within the data repository is limited to vendor representatives assigned to the customer.
